(19) United States
(12) Patent Application Publication
(10) Pub. No.: US 2024/0162565 A1
(43) Pub. Date: May 16, 2024

(54) SEPARATOR FOR RECHARGEABLE LITHIUM BATTERY, NEGATIVE ELECTRODE-SEPARATOR ASSEMBLY AND RECHARGEABLE LITHIUM BATTERY

(71) Applicants: SAMSUNG SDI CO., LTD., Yongin-si (KR); Industry-Academic Cooperation Foundation, Dankook University, Yongin-si (KR)

(72) Inventors: Duckjae YOU, Yongin-si (KR); Kyoseon KOO, Yongin-si (KR); Junghyun NAM, Yongin-si (KR); Jeunggi MOON, Yongin-si (KR); Hyo-jung SONG, Yongin-si (KR); Mihwa YANG, Yongin-si (KR); Hosung YANG, Yongin-si (KR); Jinhee LEE, Yongin-si (KR); Jinyoung JANG, Seoul (KR); Byoung-Sun LEE, Yongin-si (KR); Hyeji SHIN, Seongnam-si (KR); Heeyeon KIM, Seongnam-si (KR)

(21) Appl. No.: 18/229,587

(22) Filed: Aug. 2, 2023

(30) Foreign Application Priority Data
Nov. 2, 2022 (KR) 10-2022-0144582

(51) Int. Cl. H01M 50/434; H01M 4/38; H01M 4/485; H01M 4/62; H01M 50/46

(52) U.S. Cl. CPC H01M 50/434; H01M 4/386; H01M 4/485; H01M 4/623; H01M 50/46; H01M 10/052

(57) ABSTRACT

A separator for a rechargeable lithium battery, negative electrode-separator assembly for a rechargeable lithium battery, and rechargeable lithium battery are provided. The separator includes a ceramic layer including ceramic particles and a binder, and a functional layer on the ceramic layer including inorganic particles having a working potential (vs Li/Li+) of greater than or equal to about 1 V and a binder.

### CROSS-REFERENCE TO RELATED APPLICATION

This application claims priority to and the benefit of Korean Patent Application No. 10-2022-0144582, filed in the Korean Intellectual Property Office on Nov. 2, 2022, the entire content of which is hereby incorporated by reference.

### BACKGROUND

### 1. Field

Embodiments of the present disclosure relate to a separator for a rechargeable lithium battery, a negative electrode-separator assembly, and a rechargeable lithium battery.

### 2. Description of the Related Art

Energy densities of rechargeable lithium batteries have grown by about 5.5 Wh/kg per year, reaching over about 250 Wh/kg as of 2018. In order to achieve such high energy densities, designs of rechargeable lithium batteries have been in progress to minimize or reduce a relative amount or volume of parts not contributing to energy storage capacity, such as separators, binders, current collectors, and/or the like, and to maximize or increase an amount of active materials storing lithium. A design for increasing the loading amount of an active material per unit area to about 5 mAh/cm² or more has an effect of relatively reducing the amount of the current collector, the separator, and/or the like, improving the energy density.

However, when the loading amount of the active material is increased in this way, current density per unit area is increased, so that lithium dendrites are easily formed on the surface of an electrode, which can cause a short-circuit. During a short-circuit, as an electrical path is formed between positive and negative electrodes, a joule heating phenomenon may occur, causing a shrinkage of the separator, which leads to a larger contact between the positive and negative electrodes and then, to then cause thermal runaway, which may eventually, lead to a possible ignition issue or accident.

In order to prevent or substantially prevent this problem, efforts to enhance heat resistance and mechanical strength by coating an inorganic material such as Al₂O₃, etc. on the surface of the separator such as polyolefin, etc. have been made. Nevertheless, large and small battery ignition accidents still seem to have been reported. Because these accidents may occur due to a thermal shrinkage of the separator, development of a novel or enhanced separator capable of separating/insulating the positive and negative electrodes without the aforementioned problematic separator issue(s) of the related art is desired or required.

### SUMMARY

Aspects of one or more embodiments of the present disclosure are directed toward achieving high-capacity, high density, and long life-cycle characteristics for a rechargeable lithium battery and securing battery safety by preventing or reducing a sharp shrinkage of a separator due to a short-circuit and suppressing formation of lithium dendrite and a side reaction on the negative electrode surface.

Additional aspects will be set forth in part in the description which follows and, in part, will be apparent from the description, or may be learned by practice of the presented embodiments of the disclosure.

In one or more embodiments of the present disclosure, a separator for a rechargeable lithium battery includes a ceramic layer including ceramic particles and a binder, and a functional layer on the ceramic layer including inorganic particles having a working potential (vs Li/Li⁺) of greater than or equal to about 1 V and a binder.

In one or more embodiments, a negative electrode-separator assembly for a rechargeable lithium battery includes a negative electrode, a functional layer on the negative electrode and including inorganic particles having a working potential (vs Li/Li⁺) of greater than or equal to about 1 V and a binder, and a ceramic layer on the functional layer and including ceramic particles and a binder.

One or more embodiments of the present disclosure provide a rechargeable lithium battery including the negative electrode-separator assembly, a positive electrode, and an electrolyte.

The separator for a rechargeable lithium battery according to one or more embodiments replaces a polyolefin-based separator of the related art and has excellent or suitable shape retention at high temperatures, preventing or reducing rapid shrinkage of the separator due to a short-circuit and suppressing the formation of lithium dendrites and side reactions on the surface of the negative electrode. Accordingly, it is possible to secure the safety of the battery while achieving high capacity, high density, and long life-cycle (cycle life) characteristics of the rechargeable lithium battery.

### BRIEF DESCRIPTION OF THE DRAWINGS

FIG. 1 is a schematic view illustrating a rechargeable lithium battery according to one or more embodiments of the present disclosure.

FIGS. 2 and 3 are scanning electron microscope (SEM) images each showing a surface of a ceramic layer taken immediately after providing the ceramic layer in Example 1.

FIGS. 4 and 5 are SEM images each showing the surface of the ceramic layer taken after calendering in Example 1.

FIGS. 6 and 7 are SEM images of cross-sections each being of a negative electrode-separator assembly taken after calendering in Example 1.

FIG. 8 is a graph showing voltage according to specific capacity at 1st, 3rd, 15th, 25th, 50th, and 100th cycles for the battery cell of Comparative Example 1, as an evaluation of charge/discharge behavior.

FIG. 9 is a graph showing voltage according to specific capacity at 1st, 3rd, 15th, 25th, 50th, and 100th cycles for the battery cell of Example 1;

FIG. 10 is a SEM image of the surface of the negative electrode of Comparative Example 1 after 100 cycles.

FIG. 11 is a SEM image of a cross-section of the negative electrode of Comparative Example 1 after 100 cycles.

FIG. 12 is a SEM image of the surface of the ceramic layer of Example 1 after 100 cycles.

FIG. 13 is a SEM image of a cross-section of the negative electrode-separator assembly of Example 1 after 100 cycles.

FIG. 14 is a graph showing charge/discharge capacities and coulombic efficiencies of battery cells of Example 1 and Comparative Example 1 over 220 cycles.

FIG. 15 is a graph showing voltage changes according to specific capacity at 40th, 80th, 120th, 160th, and 200th cycles for the battery cell of Comparative Example 1.

FIG. 16 is a graph showing voltage change according to specific capacity at 40th, 80th, 120th, 160th, and 200th cycles for the battery cell of Example 1.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

Embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise.

As used herein, “combination thereof” means a mixture, laminate, composite, copolymer, alloy, blend, reaction product, and/or the like of the constituents.

It should be further understood that terms such as “comprises,” “includes,” or “have” when used in this specification, are intended to specify the presence of the stated feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout, and duplicative descriptions thereof may not be provided.

It will be understood that when an element such as a layer, film, region, or substrate is referred to as being “on” another element, it can be directly on the other element or one or more intervening elements may also be present. In contrast, when an element is referred to as being “directly on” another element, there are no intervening elements present. In addition, it will also be understood that when an element or layer is referred to as being “between” two elements or layers, it can be the only element or layer between the two elements or layers, or one or more intervening elements or layers may also be present.

In addition, “layer” herein includes not only a shape formed on the whole surface when viewed from a plan view, but also a shape formed on a partial surface.

In the present disclosure, when particles are spherical, “diameter” indicates a particle diameter or an average particle diameter, and when the particles are non-spherical, the “diameter” indicates a major axis length or an average major axis length. In addition, the average particle diameter (or size) may be measured by a generally available and/or suitable method in the art, for example, may be measured by a particle size analyzer, or may be measured by a transmission electron micrograph or a scanning electron micrograph. Additionally, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

As used herein, the term “and/or” includes any and all combinations of one or more of the associated listed items.

Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

Herein, “or” is not to be construed as an exclusive meaning, for example, “A or B” is construed to include A, B, A+B, and/or the like.

### Separator

In one or more embodiments, a separator for a rechargeable lithium battery includes a ceramic layer including ceramic particles and a binder, and a functional layer including inorganic particles having a working potential (vs. Li/Li⁺) of greater than or equal to about 1 V and a binder on the ceramic layer.

The separator does not separately include a substrate such as polyolefin and/or the like but functions as a separator by itself. The separator, compared with a separator of the related art, such as polyolefin and/or the like, has high shape retention at high temperatures, so it is less prone to shrinking in the event of a short circuit, which can improve safety of a battery. For example, the separator has shape and structural stability at about 150° C. In one or more embodiments, the separator has a smaller volume, thickness, and relative amount in a rechargeable lithium battery than the separator in the related art and thus is advantageous for manufacturing a high-capacity, high density battery. Furthermore, a rechargeable lithium battery manufactured by applying the separator may be effectively suppress or reduce side reactions occurring on the negative electrode surface and thereby improve overall performance such as life cycle characteristics and/or the like, compared with a case of applying the separator of the related art.

In an embodiment, the working potential (vs. Li/Li⁺) of the inorganic particles can be measured by performing a charge and discharge using a charge and discharge test system (WBCS3000, WonATech) under 25° C. conditions and in a voltage range of 0V to 4V and a current rate of 0.1C for a cell with the inorganic particles as a cathode, lithium metal as an anode and an electrolyte solution of 1 M LiPF₆ in EC/DEC (5:5 vol %). The working potential of the inorganic particles can also be found in “https://onlinelibrary.wiley.com/doi/full/10.1002/inf2.12228”, or “https://link.springer.com/article/10.1007/s10800-013-0651-1”.

The working potential (vs. Li/Li⁺) of the inorganic particles may be, for example, 1 V to 3 V, 1.1 V to 3 V, 1.2 V to 3 V, 1.3 V to 2.5 V, or 1.5 V to 2 V.

### Ceramic Layer

The ceramic layer is a layer including ceramic particles and a binder, and may be referred to as a layer substantially serving as a separator. The ceramic layer may also be referred to as a layer including greater than or equal to about 50 wt % of the ceramic particles.

The ceramic layer may have a thickness of about 1 μm to about 100 μm, for example, about 5 μm to about 90 μm, about 10 μm to about 80 μm, or about 20 μm to about 60 μm. The ceramic layer may function as a sufficient separator even with a thinner thickness than a polyolefin-based separator of the related art and may exhibit higher shape retention at high temperatures.

The ceramic particles may be referred to as inorganic materials that are electrochemically inactive. The ceramic particles may include for example at least one of (e.g., one selected from) silicon oxide, aluminum oxide, boehmite, zinc oxide, zirconium oxide, zeolite, titanium oxide, barium titanate, strontium titanate, calcium titanate, aluminum borate, calcium carbonate, barium carbonate, lead oxide, cerium oxide, calcium oxide, magnesium oxide, niobium oxide, tantalum oxide, tungsten oxide, aluminum phosphate, calcium silicate, zirconium silicate, titanium silicate, montmorillonite, saponite, vermiculite, and/or hydrotalcite. For example, the ceramic particles may include silicon oxide, aluminum oxide, boehmite, or a combination thereof, which is electrochemically inactive.

An average particle diameter (D50) of the ceramic particles may be about 10 nm to about 30 μm, for example, about 10 nm to about 25 μm, about 10 nm to about 20 μm, about 10 nm to about 10 μm, about 20 nm to about 5 μm, about 30 nm to about 3 μm, or about 50 nm to about 900 nm. For example, the ceramic particles may be nano particles having several to hundreds of nanometers of an average particle diameter (i.e., in the nanometer scale). When the ceramic particles satisfy the average particle diameter ranges, it is advantageous to form the ceramic layer as a thin film with high density and with a thin thickness.

The ceramic particles may be included in an amount of greater than or equal to about 50 wt %, for example, about 50 wt % to about 99 wt %, for example, about 60 wt % to about 95 wt %, about 70 wt % to about 90 wt %, or about 75 wt % to about 85 wt % based on 100 wt % of the ceramic layer. The ceramic layer may exhibit a high-density film form while performing a (sufficient) function of a separator by including the ceramic particles in the above content (e.g., amount) ranges.

The ceramic layer includes a binder that serves to bind the ceramic particles together. The binder may include for example at least one of (e.g., one selected from) polyvinylidene fluoride, polyvinylidene fluoride-hexafluoropropylene, polyvinylidene fluoride-trichloroethylene, polyvinylidene fluoride-chlorotrifluoroethylene, polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyethylene, polypropylene, a styrene-butadiene rubber, an acrylated styrene-butadiene rubber, an acrylonitrile-butadiene rubber, polyamideimide, and/or polyimide.

For example, the binder of the ceramic layer may be a fluorine-based binder, and may be for example, at least one of (e.g., one selected from) polyvinylidene fluoride, polyvinylidene fluoride-hexafluoropropylene, polyvinylidene fluoride-trichloroethylene, and/or polyvinylidene fluoride-chlorotrifluoroethylene. This fluorine-based binder may effectively bind the ceramic particles even in a small amount without adversely affecting the rechargeable lithium battery and form the ceramic layer as a flat film.

The binder may be included in an amount of about 1 wt % or more based on about 100 wt % of the ceramic layer, for example, about 1 wt % to about 50 wt %, for example about 5 wt % to about 40 wt %, or about 10 wt % to about 30 wt %. When the binder satisfies the above ranges, a firm ceramic layer may be formed without adversely affecting the rechargeable lithium battery.

### Functional Layer

The functional layer is disposed on one side or both sides of the above ceramic layer and includes about 50 wt % or more of an inorganic material having an electrochemically high working voltage (working potential). For example, the functional layer includes inorganic particles having a working potential (vs Li/Li⁺) of greater than or equal to about 1 V. These inorganic particles may be said to have a higher working voltage than a voltage at which an electrolyte solution generally utilized in a rechargeable lithium battery is electrochemically decomposed. The functional layer including these inorganic particles may effectively suppress or reduce side reactions on the electrode surface between an electrode and an electrolyte solution, improving overall performance of a rechargeable lithium battery such as life-cycle characteristics.

The functional layer may have a thinner thickness than that of the ceramic layer, for example, about 1 μm to about 20 μm, about 2 μm to about 15 μm, or about 3 μm to about 10 μm. The functional layer has a very thin thickness and thus may effectively suppress or reduce a side reaction on the electrode interface without adversely affecting the rechargeable lithium battery.

The inorganic particles of the functional layer may include for example, at least one of (e.g., one selected from) lithium titanium oxide, lithium zirconium oxide, lithium aluminum oxide, lithium niobium oxide, lithium lanthanum oxide, lithium tantalum oxide, lithium zinc oxide, lithium titanium zirconium oxide, lithium lanthanum titanium oxide, lithium lanthanum zirconium oxide, lithium lanthanum titanium zirconium oxide, and/or lithium lanthanum zirconium aluminum oxide.

The inorganic particles may have an average particle diameter (D50) of about 10 nm to about 30 μm, for example, about 10 nm to about 25 μm, about 10 nm to about 20 μm, about 10 nm to about 10 μm, about 20 nm to about 5 μm, about 30 nm to about 3 μm, or about 50 nm to about 900 nm. For example, the inorganic particles may be nano particles having several to hundreds of nanometer of an average particle diameter. When the inorganic particles satisfy the average particle diameter ranges, it is advantageous to form a functional layer with high density and a thin thickness.

The inorganic particles may be included in an amount of about 50 wt % or more based on about 100 wt % of the functional layer, for example, about 50 wt % to about 99 wt %, for example, about 60 wt % to about 95 wt %, about 70 wt % to about 90 wt %, or about 75 wt % to about 85 wt %. The functional layer includes the inorganic particles within the content (e.g., amount) ranges and thus may be a film suppressing a side reaction on the electrode interface and exhibiting high density.

Like the ceramic layer described above, the functional layer includes a binder that binds inorganic particles. The binder may include, for example, at least one of (e.g., one selected from) polyvinylidene fluoride, polyvinylidene fluoride-hexafluoropropylene, polyvinylidene fluoride-trichloroethylene, polyvinylidene fluoride-chlorotrifluoroethylene, polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyethylene, polypropylene, a styrene-butadiene rubber, an acrylated styrene-butadiene rubber, an acrylonitrile-butadiene rubber, polyamideimide, and/or polyimide.

The binder of the functional layer may be a fluorine-based binder, and may include at least one of (e.g., one selected from) polyvinylidene fluoride, polyvinylidene fluoride-hexafluoropropylene, polyvinylidene fluoride-trichloroethylene, and/or polyvinylidene fluoride-chlorotrifluoroethylene. This fluorine-based binder may effectively bind inorganic particles even in a small amount without adversely affecting the rechargeable lithium battery and form a flat film-like functional layer.

The binder may be included in an amount of about 1 wt % or more based on about 100 wt % of the functional layer, for example, about 1 wt % to about 50 wt %, for example, about 5 wt % to about 40 wt %, or about 10 wt % to about 30 wt %. When the binder is included within the ranges, a firm functional layer may be formed without adversely affecting a rechargeable lithium battery.

The ceramic layer and the functional layer may be, for example, formed in an electospraying method, and it is advantageous to form them as a layer with thin thickness and high density.

### Negative Electrode-Separator Assembly

In one or more embodiments, a negative electrode-separator assembly for a rechargeable lithium battery includes a negative electrode, a functional layer disposed on the negative electrode and including inorganic particles having a working potential (vs. Li/Li⁺) of greater than or equal to about 1 V and a binder, and a ceramic layer disposed on the functional layer and including ceramic particles and a binder. In the assembly, the ceramic layer and the functional layer serve as a separator and also serve as a negative electrode-separator assembly in itself without including a separate substrate such as polyolefin and/or the like.

The functional layer has an excellent or suitable effect of suppressing side reactions between the negative electrode and the electrolyte solution on the negative electrode surface and may be in contact with the negative electrode in the assembly. A detailed description of the functional layer and the ceramic layer is the same as above and may not be repeated.

Any negative electrode in the negative electrode-separator assembly may be applied without limitation as long as it is a general negative electrode utilized in a rechargeable lithium battery. For example, the negative electrode may include a current collector and a negative electrode active material layer disposed on the current collector, and the negative electrode active material layer may include a negative electrode active material, and may optionally further include a binder and a conductive material.

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include, for example crystalline carbon, amorphous carbon, or a combination thereof as a carbon-based negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and/or the like. For example, the negative electrode active material may include graphite, and in this case, the negative electrode may be referred to as a graphite-based negative electrode.

The lithium metal alloy includes an alloy of lithium and a metal of (e.g., selected from) Na, K, Rb, Cs, Fr, Be, Mg, Ca, Sr, Si, Sb, Pb, In, Zn, Ba, Ra, Ge, Al, and/or Sn.

The material capable of doping/dedoping lithium may be a Si-based negative electrode active material and/or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and/or a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and/or a combination thereof, but not Sn). At least one of these materials may be mixed with SiO₂. The elements Q and R may be (e.g., may be selected from) Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and/or a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content (e.g., amount) of silicon may be about 10 wt % to about 50 wt % based on the total weight of the silicon-carbon composite. In one or more embodiments, the content (e.g., amount) of the crystalline carbon may be about 10 wt % to about 70 wt % based on the total weight of the silicon-carbon composite, and the content (e.g., amount) of the amorphous carbon may be about 20 wt % to about 40 wt % based on the total weight of the silicon-carbon composite. In one or more embodiments, a thickness of the amorphous carbon coating layer may be about 5 nm to about 100 nm. An average particle diameter (D50) of the silicon particles may be about 10 nm to about 20 μm. The average particle diameter (D50) of the silicon particles may be about 10 nm to about 200 nm. The silicon particles may exist in an oxidized form, and in this case, an atomic content (e.g., amount) ratio of Si:O in the silicon particles indicating a degree of oxidation may be about 99:1 to about 33:67. The silicon particles may be SiOₓ particles, and in this case, the range of x in SiOₓ may be greater than about 0 and less than about 2. In the present specification, as utilized herein, when a definition is not otherwise provided, an average particle diameter (D50) indicates a diameter of particles having a cumulative volume of 50 volume % in the particle size distribution.

The Si-based negative electrode active material and/or Sn-based negative electrode active material may be mixed with the carbon-based negative electrode active material. When (1) the Si-based negative electrode active material and/or Sn-based negative electrode active material and (2) the carbon-based negative electrode active material are mixed and utilized, the mixing ratio (1):(2) may be a weight ratio of about 1:99 to about 90:10.

In one example, the negative electrode active material may include a carbon-based anode active material, and specifically may include graphite. In the negative electrode-separator assembly, the functional layer may effectively suppress or reduce side reactions occurring on the surface of the graphite negative electrode. The negative electrode active material may include a carbon-based negative electrode active material and a silicon-based negative electrode active material. The silicon-based negative electrode active material may include at least one of (e.g., one selected from) silicon, silicon oxide, a silicon-carbon composite, and/or a silicon alloy, and details are as described above.

In the negative electrode active material layer, the negative electrode active material may be included in an amount of about 90 wt % to about 99 wt % based on the total weight of the negative electrode active material layer.

The binder serves to adhere (or securely adhere) the negative electrode active material particles to each other and also to adhere the negative electrode active material to the current collector. The binder may be a water-insoluble binder, a water-soluble binder, or a combination thereof.

The water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber binder or a polymer resin binder. The rubber binder may include (e.g., may be selected from) a styrene-butadiene rubber, an acrylated styrene-butadiene rubber, an acrylonitrile-butadiene rubber, an acrylic rubber, a butyl rubber, a fluororubber, and/or a combination thereof. The polymer resin binder may include (e.g., may be selected from) polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and/or a combination thereof.

When a water-soluble binder is utilized as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and utilized. The alkali metal may be Na, K, or Li. The amount of such a thickener utilized may be about 0.1 parts by weight to about 3 parts by weight based on 100 parts by weight of the negative electrode active material.

A content (e.g., amount) of the binder in the negative electrode active material layer may be about 0.1 wt % to about 10 wt %, or about 1 wt % to about 5 wt % based on the total weight of the negative electrode active material layer.

The conductive material is included to provide electrode conductivity and any electrically conductive material may be utilized as a conductive material unless it causes a chemical change. Examples of the conductive material include a carbon-based material such as natural graphite, artificial graphite, carbon black, acetylene black, ketjen black, a carbon fiber, a carbon nanofiber, carbon nanotube, and/or the like; a metal-based material of a metal powder or a metal fiber including copper, nickel, aluminum, silver, and/or the like; a conductive polymer such as a polyphenylene derivative; or a mixture thereof.

A content (e.g., amount) of the conductive material in the negative electrode active material layer may be about 0.1 wt % to about 10 wt %, or about 1 wt % to about 5 wt % based on the total weight of the negative electrode active material layer.

The negative electrode current collector may include one of (e.g., one selected from) a copper foil, a nickel foil, a stainless steel foil, a titanium foil, a nickel foam, a copper foam, a polymer substrate coated with a conductive metal, and/or a combination thereof.

The negative electrode may have a thickness of about 20 μm to about 200 μm, for example, about 30 μm to about 150 μm, or about 40 μm to about 100 μm. The thickness of the negative electrode may be appropriately or suitably adjusted according to the purpose of the battery.

The negative electrode-separator assembly may have a structure in which a current collector, a negative electrode active material layer, a functional layer, and a ceramic layer are sequentially stacked.

In one or more embodiments, a method for manufacturing a negative electrode-separator assembly is provided. The method of manufacturing the negative electrode-separator assembly includes (i) preparing a negative electrode, (ii) electrospraying a functional layer composition including inorganic particles having a working potential (vs Li/Li+) of greater than or equal to about 1 V and a binder onto the negative electrode to form a functional layer, (iii) electrospraying a ceramic layer composition including ceramic particles and a binder on the functional layer to form a ceramic layer, and (iv) calendering to obtain a negative electrode-separator assembly. Through the above method, the aforementioned negative electrode-separator assembly may be efficiently manufactured.

### Rechargeable Lithium Battery

In one or more embodiments, a rechargeable lithium battery includes the aforementioned negative electrode-separator assembly, a positive electrode, and an electrolyte.

The positive electrode may be disposed on a ceramic layer in the negative electrode-separator assembly, and may be, for example, in contact with the ceramic layer. Also, the electrolyte may be a non-aqueous electrolyte.

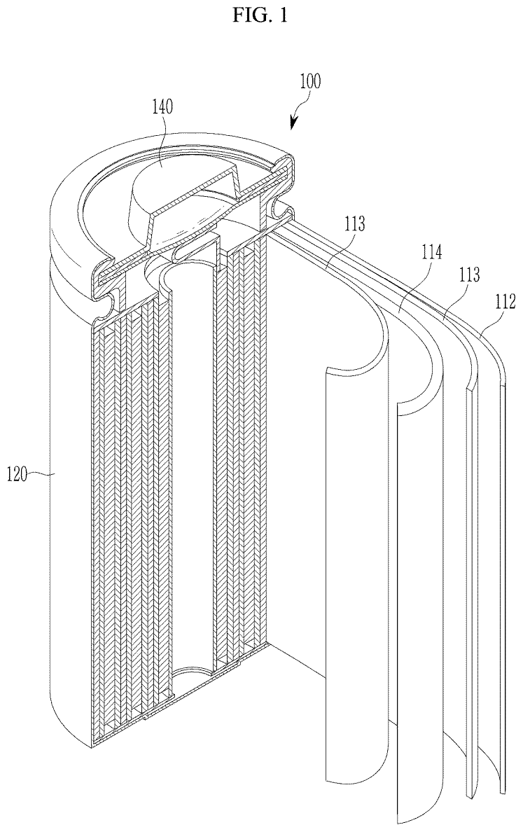

FIG. 1 is a schematic view illustrating a rechargeable lithium battery according to one or more embodiments of the present disclosure. Referring to FIG. 1, a rechargeable lithium battery 100 according to one or more embodiments includes a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120. The separator 113 may be a separator according to one or more embodiments including the ceramic layer and the functional layer described above, and the negative electrode 112 and the separator 113 may be configured as an assembly as described above.

### Positive Electrode

As the positive electrode, any positive electrode generally utilized in a rechargeable lithium battery may be applied without limitation. For example, the positive electrode may include a current collector and a positive electrode active material layer positioned on the current collector. The positive electrode active material layer may include a positive electrode active material and may further include a binder and/or a conductive material.

As the positive electrode active material, any material generally utilized in a rechargeable lithium battery may be applied without limitation. For example, the positive electrode active material may be a compound being capable of intercalating and deintercalating lithium, and may include one or more compounds represented by one or more of the following chemical formulas: LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}Co_{b}X_{c}O_{2-α}T₂ (0.90≤a≤1.8, 0≤b≤0.5, 0≤c≤0.05, 0<α<2); LiₐNi_{1-b-c}Mn_{b}X_{c}D_{α} (0.90≤a≤1.8, 0≤b≤0.5, 0≤c≤0.05, 0<α≤2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂ (PO₄)₃ (0≤f≤2); Li_{(3-f)}Fe₂(PO₄)₃ (0≤f≤2); and/or LiₐFePO₄ (0.90≤a≤1.8).

In the chemical formulas, A is (e.g., is selected from) Ni, Co, Mn, and/or a combination thereof; X is (e.g., is selected from) Al, Ni, Co, Mn, Cr, Fe, Mg, Sr, V, a rare earth element, and/or a combination thereof; D is (e.g., is selected from) O, F, S, P, and/or a combination thereof; E is (e.g., is selected from) Co, Mn, and/or a combination thereof; T is (e.g., is selected from) F, S, P, and/or a combination thereof; G is (e.g., is selected from) Al, Cr, Mn, Fe, Mg, La, Ce, Sr, V, and/or a combination thereof; Q is (e.g., is selected from) Ti, Mo, Mn, and/or a combination thereof; Z is (e.g., is selected from) Cr, V, Fe, Sc, Y, and/or a combination thereof; and J is (e.g., is selected from) V, Cr, Mn, Co, Ni, Cu, and/or a combination thereof.

The positive electrode active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium iron phosphate (LFP).

The positive electrode active material may include a lithium nickel-based oxide represented by Chemical Formula 1, a lithium cobalt-based oxide represented by Chemical Formula 2, a lithium iron phosphate-based compound represented by Chemical Formula 3, or a combination thereof.

Liₐ₁Niₓ₁M¹_{y1}M²_{1-x1-y1}O₂ Chemical Formula 1

In Chemical Formula 1, 0.9≤a1≤1.8, 0.3≤x1≤1, 0≤y1≤0.7, and M¹ and M² may each independently be at least one element of (e.g., one element selected from) Al, B, Ba, Ca, Ce, Co, Cr, Cu, F, Fe, Mg, Mn, Mo, Nb, P, S, Si, Sr, Ti, V, W, and/or Zr.

Liₐ₂Coₓ₂M³₁₋ₓ₂O₂ Chemical Formula 2

In Chemical Formula 2, 0.9≤a2≤1.8, 0.6≤x2≤1, and M³ is at least one element of (e.g., one element selected from) Al, B, Ba, Ca, Ce, Cr, Cu, F, Fe, Mg, Mn, Mo, Nb, P, S, Si, Sr, Ti, V, W, and/or Zr.

Liₐ₃Feₓ₃M⁴₍₁₋ₓ₃₎PO₄ Chemical Formula 3

In Chemical Formula 3, 0.9≤a3≤1.8, 0.6≤x3≤1, and M⁴ is at least one element of (e.g., one element selected from) Al, B, Ba, Ca, Ce, Co, Cr, Cu, F, Fe, Mg, Mn, Mo, Nb, P, S, Si, Sr, Ti, V, W, and/or Zr.

The positive electrode active material may have an average particle diameter (D50) of about 1 μm to about 25 μm, for example about 1 μm to about 20 μm, about 1 μm to about 18 μm, about 3 μm to about 15 μm, or about 5 μm to about 15 μm. The positive electrode active material having a particle diameter within the ranges may be harmoniously mixed with the other components in the positive electrode active material layer and realize high capacity and high energy density.

The positive electrode active material may be in the form of secondary particles formed through agglomeration of a plurality of primary particles or in the form of single particles. In one or more embodiments, the positive electrode active material may have a spherical shape, a shape near to the spherical shape, a polyhedronal shape, and.or an amorphous shape.

The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

A content (e.g., amount) of the binder in the positive electrode active material layer may be about 1 wt % to about 5 wt % based on the total weight of the positive electrode active material layer.

The conductive material is included to provide electrode conductivity and any electrically conductive material may be utilized as a conductive material unless it causes a chemical change. Examples of the conductive material include a carbon-based material such as natural graphite, artificial graphite, carbon black, acetylene black, ketjen black, a carbon fiber, a carbon nanofiber, carbon nanotube, and/or the like; a metal-based material of a metal powder or a metal fiber including copper, nickel, aluminum, silver, and/or the like; a conductive polymer such as a polyphenylene derivative; or a mixture thereof.

A content (e.g., amount) of the conductive material in the positive electrode active material layer may be about 1 wt % to about 5 wt % based on the total weight of the positive electrode active material layer.

An aluminum foil may be utilized as the positive electrode current collector, but the present disclosure is not limited thereto.

### Electrolyte

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like and the ketone-based solvent may be cyclohexanone, and/or the like. In one or more embodiments, the alcohol-based solvent may be ethyl alcohol, isopropyl alcohol, etc. and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and/or the like.

The non-aqueous organic solvent may be utilized singularly or in a mixture, When the organic solvent is utilized in a mixture, the mixture ratio may be controlled or selected in accordance with a desirable battery performance.

In one or more embodiments, in the case of the carbonate-based solvent, a mixture of a cyclic carbonate and a chain carbonate may be utilized. In this case, when the cyclic carbonate and the chain carbonate are mixed in a volume ratio of about 1:1 to about 1:9, the electrolyte may exhibit excellent or suitable performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be utilized.

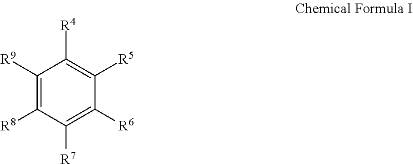

In Chemical Formula I, R⁴ to R⁹ may each independently be the same or different and are (e.g., are selected from) hydrogen, a halogen, a C1 to C10 alkyl group, a C1 to C10 haloalkyl group, and/or a combination thereof.

Specific examples of the aromatic hydrocarbon-based solvent may be (e.g., may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

The electrolyte may further include vinylene carbonate or an ethylene carbonate-based compound of Chemical Formula II in order to improve life-cycle of a battery.

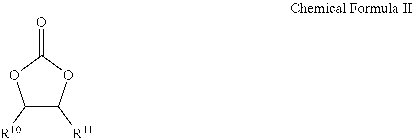

In Chemical Formula II, R¹⁰ and R¹¹ may each independently be the same or different, and are (e.g., are selected from) hydrogen, a halogen, a cyano group, a nitro group, and/or fluorinated C1 to C5 alkyl group, provided that at least one of R¹⁰ and/or R¹¹ is (e.g., is selected from) a halogen, a cyano group, a nitro group, and/or a fluorinated C1 to C5 alkyl group, but both of R¹⁰ and R¹¹ are not hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, and/or fluoroethylene carbonate. The amount of the additive for improving life-cycle characteristics may be utilized within an appropriate or suitable range.

The lithium salt dissolved in the non-aqueous organic solvent supplies lithium ions in a battery, enables a basic operation of a rechargeable lithium battery, and improves transportation of the lithium ions between positive and negative electrodes.

Examples of the lithium salt include at least one of (e.g., one selected from) LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide; LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer in a range of 1 to 20, lithium difluoro(bisoxalato) phosphate, LiCl, LiI, LiB(C₂O₄)₂ (lithium bis(oxalato) borate; LiBOB), and/or lithium difluoro(oxalato)borate (LiDFOB).

The lithium salt may be utilized in a concentration in a range of about 0.1 M to about 2.0 M. When the lithium salt is included at the above concentration range, an electrolyte may have excellent or suitable performance and lithium ion mobility due to optimal or suitable electrolyte conductivity and viscosity.

Rechargeable lithium batteries may be classified as lithium ion batteries, lithium ion polymer batteries, and lithium polymer batteries. The rechargeable lithium batteries may have a variety of shapes and sizes, and include cylindrical, prismatic, coin, or pouch-type or kind batteries, and may be thin film batteries or may be rather bulky in size. Structures and manufacturing methods for lithium ion batteries pertaining to this disclosure are generally available in the art.

The rechargeable lithium battery according to one or more embodiments may be utilized in an electric vehicle (EV), a hybrid electric vehicle such as a plug-in hybrid electric vehicle (PHEV), and portable electronic device because it implements a high capacity and has excellent or suitable storage stability, life-cycle characteristics, and high rate characteristics at high temperatures.

Hereinafter, examples of the present disclosure and comparative examples are described. It is to be understood, however, that the examples are for the purpose of illustration and are not to be construed as limiting the present disclosure.

### Example 1

### 1. Manufacture of Negative Electrode-Separator Assembly

97 wt % of graphite, 1.5 wt % of a styrene butadiene rubber binder, 1.5 wt % of carboxylmethyl cellulose, and a distilled water solvent were mixed to prepare a negative electrode active material layer composition, and the negative electrode active material layer composition was coated on a copper current collector and then, dried and roll-pressed, manufacturing a negative electrode.

80 wt % of lithium titanium oxide with a working potential (vsLi/Li⁺) of about 1.55 V and 20 wt % of a PVdF-HFP binder based on 100 wt % of the total solute excluding solvent were mixed in an N-methylpyrrolidone (NMP) solvent to prepare a functional layer composition, and this functional layer composition was electrosprayed on the surface of the graphite negative electrode to form a functional layer. The electrospraying was designed to utilize a voltage of 17 kV, TCD of 12 cm, and/a flow rate of 0.6 mL/hr, for 15 minutes.

80 wt % of SiO₂ and 20 wt % of a PVdF-HFP binder based on 100 wt % of the total solute excluding solvent were mixed in an NMP solvent to prepare a ceramic layer composition, and this ceramic layer composition was electrosprayed on the surface of the functional layer, forming a ceramic layer. The electrospraying was designed to utilize a voltage of 25 kV, TCD of 12 cm, and a flow rate of 0.2 mL/hr, for 3 hours.

Subsequently, the film was integrated through calendering to planarize the surface and increase density. Through this, a negative electrode-separator assembly with a stacked structure in the order of current collector-negative electrode active material layer-functional-ceramic layer was manufactured. A primary calendering was designed to have an interval width of 180 μm, while a secondary calendering was designed to have an interval width of 159 μm.

### 2. Manufacture of Rechargeable Lithium Battery Cell

96 wt % of a LiNi_{0.91}Co_{0.05}Al_{0.04}O₂ positive electrode active material, 2 wt % of a polyvinylidene fluoride binder, 2 wt % of a carbon nanotube conductive material, and an N-methylpyrrolidone solvent were mixed with a mixer to prepare a positive electrode active material layer composition, and this positive electrode active material layer composition was coated on an aluminum foil and then, dried and roll-pressed, manufacturing a positive electrode.

The positive electrode was stacked on the ceramic layer of the prepared negative electrode-separator assembly, manufacturing an electrode assembly. This electrode assembly was inserted into a battery case, and an electrolyte solution prepared by adding a 1.0 M LiPF₆ lithium salt in a mixed solvent of ethylene carbonate and diethyl carbonate in a volume ratio of 50:50 was injected into the case, manufacturing a rechargeable lithium battery cell.

### Comparative Example 1

A rechargeable lithium battery cell was manufactured in substantially the same manner as in Example 1 except that a polyolefin separator (Celgard 2400) was interposed between negative and positive electrodes without forming the functional layer and the ceramic layer.

### Evaluation Example 1: Confirmation of Functional Layer and Ceramic Layer

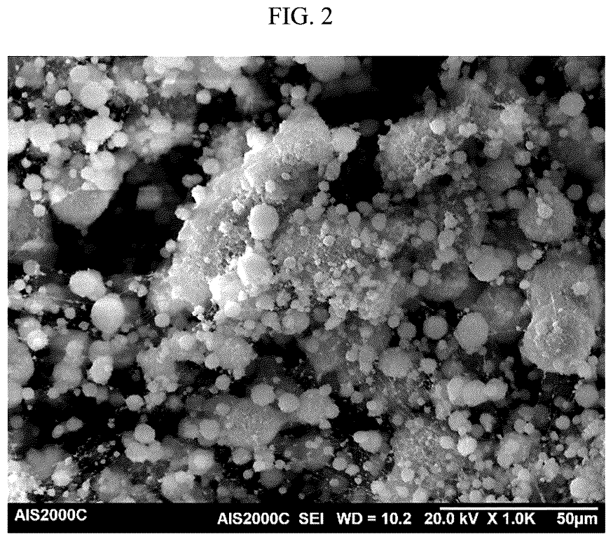

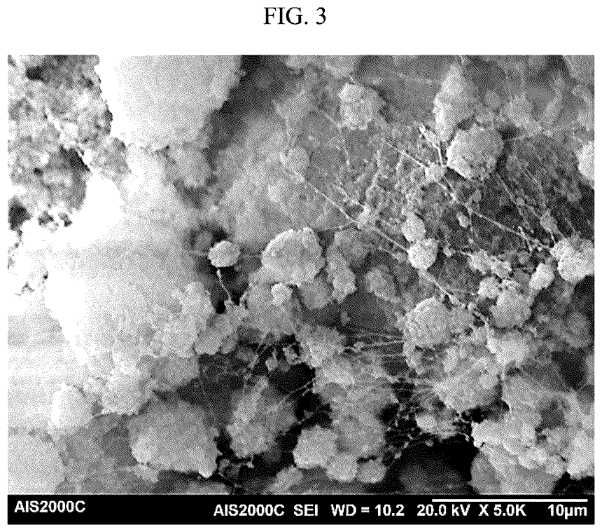

FIGS. 2 and 3 are SEM images each showing the ceramic layer surface of Example 1 after forming the ceramic layer. Referring to FIGS. 2 and 3, SiO₂ nano particles are fixed by a PVdF-HFP nanonet structure.

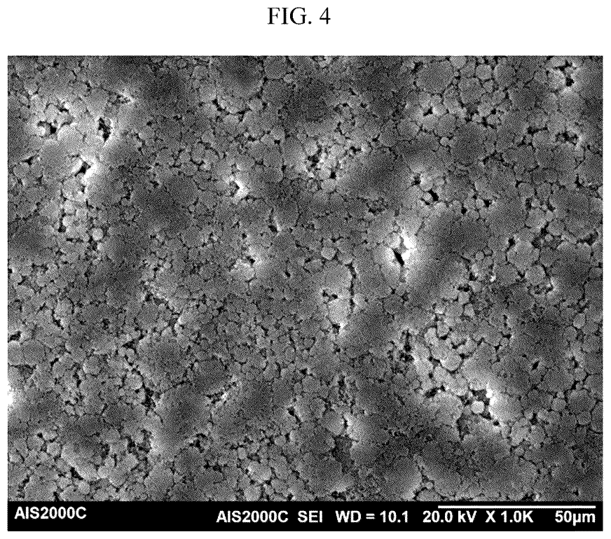

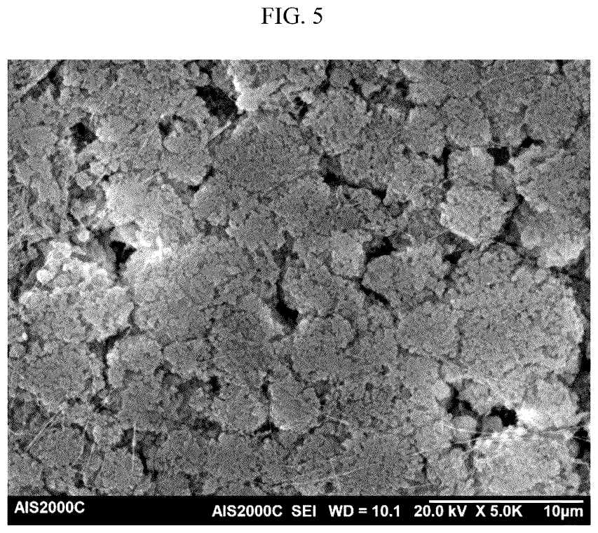

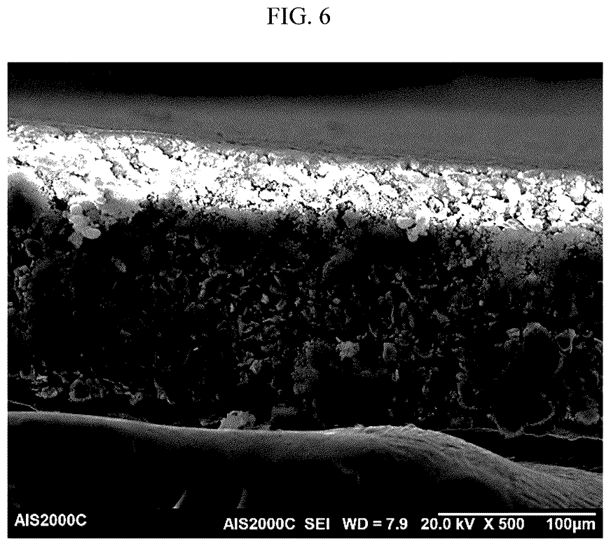

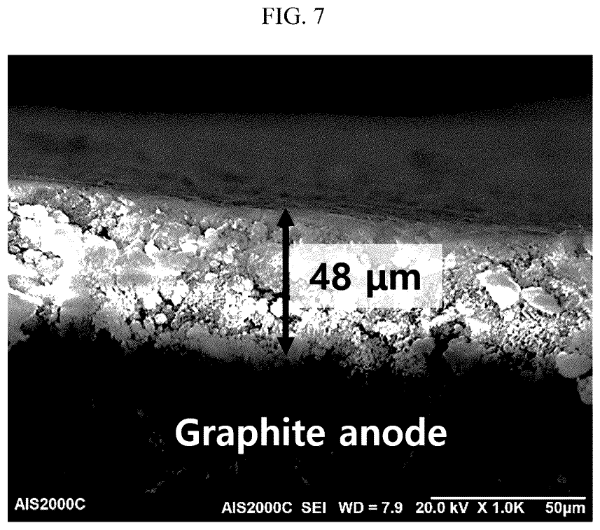

FIGS. 4 and 5 are SEM images each showing the ceramic layer surface of Example 1 after the calendering. FIGS. 4 and 5 show that porosity is reduced. FIGS. 6 and 7 are SEM images each showing a cross-section of the negative electrode-separator assembly after the calendering. On the graphite negative electrode, the functional layer and the ceramic layer are sequentially stacked, and a thickness of the functional layer and the ceramic layer, which serve as a separator, is about 48 μm. Herein, the functional layer has a thickness of about 5 to 10 μm, and the ceramic layer has a thickness of about 38 to 43 μm.

### Evaluation Example 2: Evaluation of Charge/Discharge Behavior

The rechargeable lithium battery cells according to Example 1 and Comparative Example 1 were charged under constant current (0.1 C) and constant voltage (4.25 V, 0.05 C cut-off) conditions, paused for 10 minutes, and discharged to 3.0 V under constant current (0.1 C) conditions at 25° C. as initial charge and discharge. Subsequently, the cells were repeatedly 100 times charged and discharged within substantially the same voltage range of 0.3 C/0.3 C.

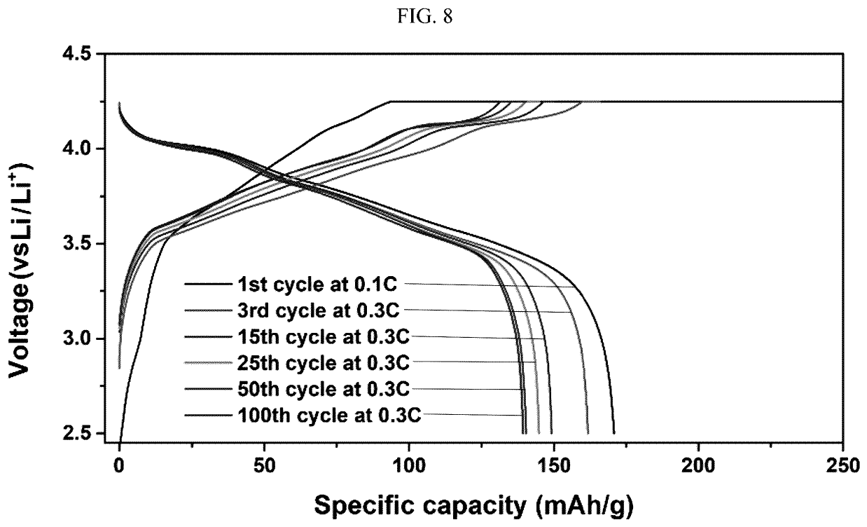

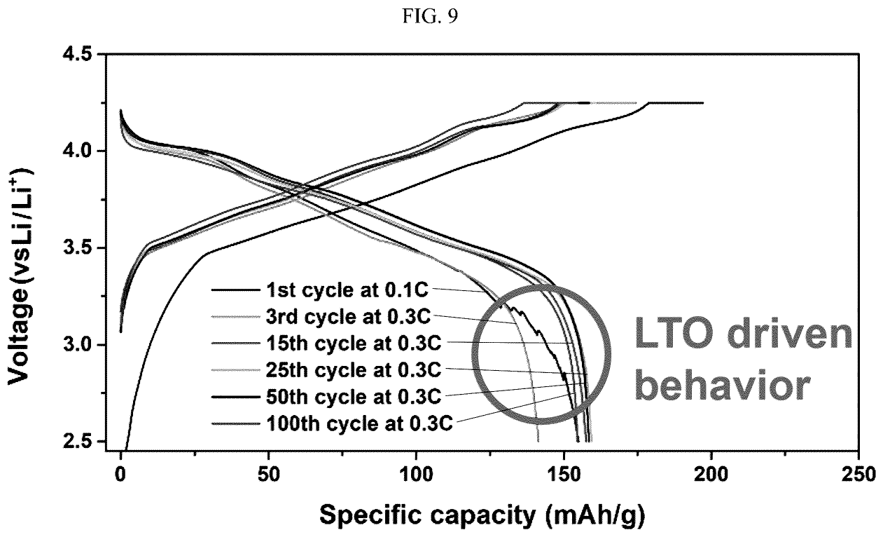

FIG. 8 is a graph showing a voltage according to specific capacity at 1st, 3rd, 15th, 25th, 50th, and 100th cycles for the battery cell of Comparative Example 1, and FIG. 9 is the same evaluation graph for the battery cell of Example 1. Referring to FIG. 9, behaviors by the ceramic layer are observed at the first cycle, and the cell of the example exhibits similar or better charge/discharge behaviors to the cell of Comparative Example 1 utilizing a polyolefin separator up to the 100 cycles.

### Evaluation Example 3: Surface Observation after 100 Cycles

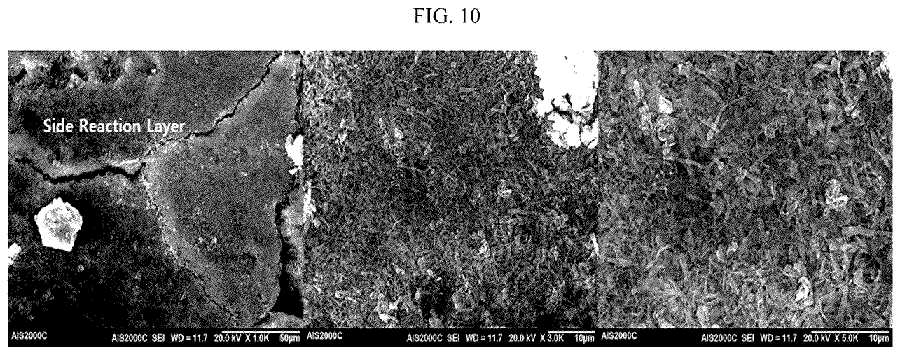

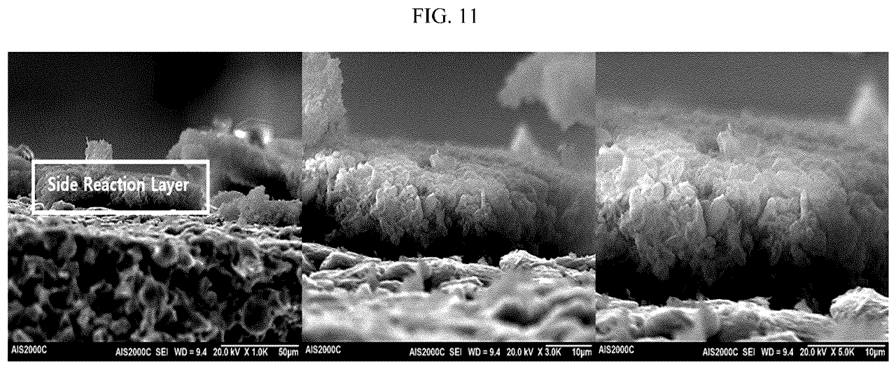

As in Evaluation Example 2, the battery cells of Example 1 and Comparative Example 1 were 100 cycles charged and discharged and then, disassembled to examine the negative electrode surfaces. FIGS. 10 and 11 are SEM images each showing the negative electrode surface of the cell of Comparative Example 1 after the 100 cycles, wherein FIG. 10 is an image showing the surface (top view), while FIG. 11 is an image showing the negative electrode cross-section (cross-section). Referring to FIGS. 10 and 11, a side reaction layer with a thickness of about 10 μm is observed.

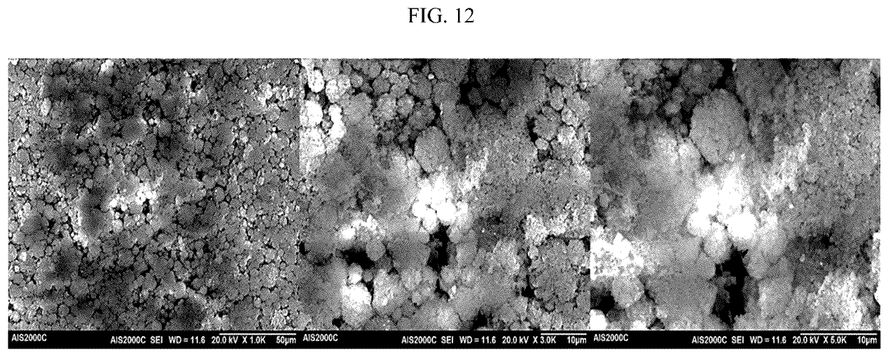

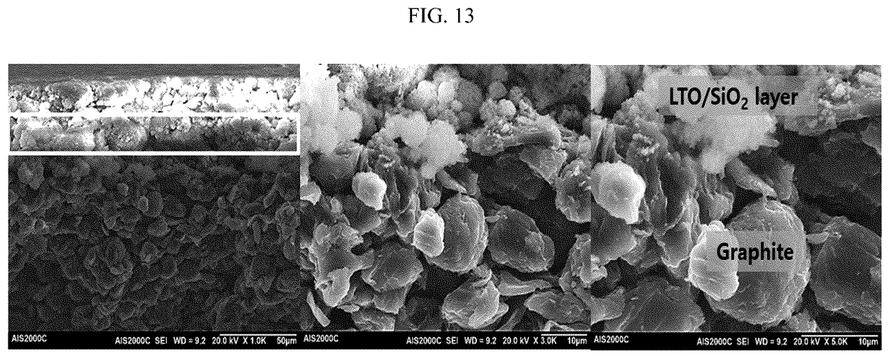

FIG. 12 is a SEM image of the surface of the ceramic layer of Example 1 after 100 cycles, and FIG. 13 is a SEM image of a cross-section of the negative electrode-separator assembly. Referring to FIGS. 12 and 13, no clear negative electrode side reaction layer is observed.

### Evaluation Example 4: Evaluation of Life-cycle Characteristics

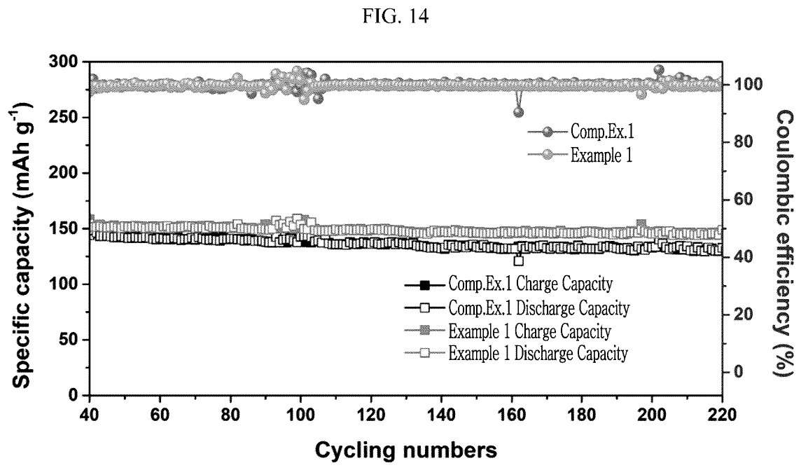

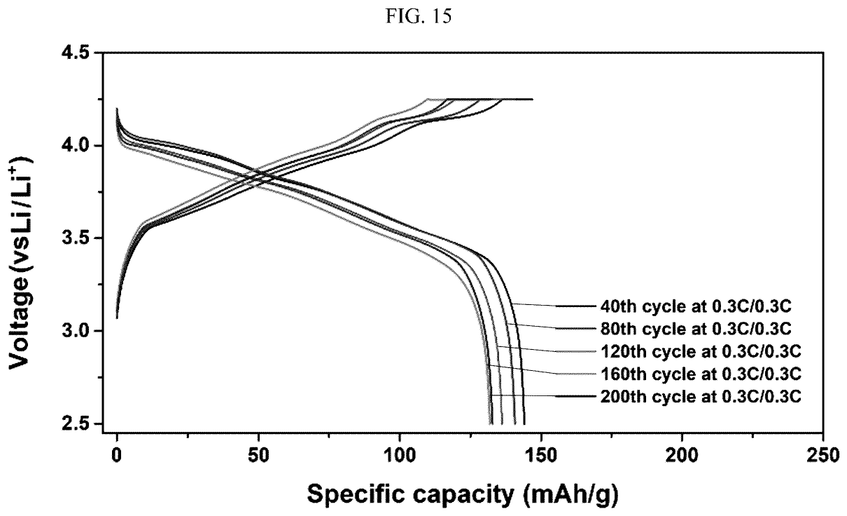

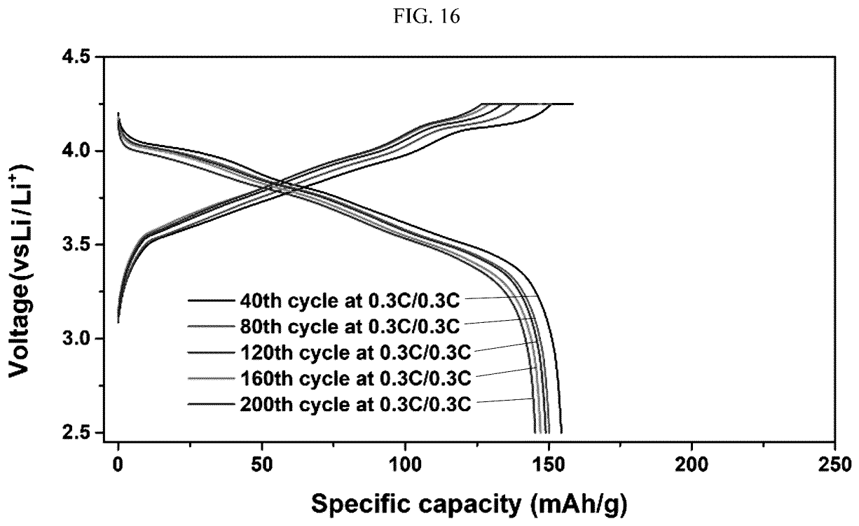

The rechargeable lithium battery cells of Example 1 and Comparative Example 1 were initially charged and discharged in substantially the same manner as in Evaluation Example 2 and then, repeatedly charged and discharged under the 0.3 C/0.3 C condition to evaluate life-cycle characteristics. FIG. 14 is a graph showing charge/discharge capacities and coulombic efficiencies of battery cells of Example 1 and Comparative Example 1 over 220 cycles. FIG. 15 is a graph showing voltage changes according to specific capacity at 40th, 80th, 120th, 160th, and 200th cycles for the battery cell of Comparative Example 1, and FIG. 16 is the same evaluation graph for the battery cell of Example 1. Referring to FIGS. 14 to 16, after the final evaluation, Example 1 had a specific capacity of 145 mAh/g, which is much higher than 130 mAh/g of Comparative Example 1 and thus confirms that Example 1 exhibits much more or improved life-cycle characteristics relative to Comparative Example 1.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The light emitting device, electronic apparatus or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

### REFERENCE NUMERALS

| | |
|---|---|
| 100: rechargeable lithium battery | 112: negative electrode |
| 113: separator | 114: positive electrode |
| 120: battery case | 140: sealing member |

What is claimed is:

1. A separator for a rechargeable lithium battery, the separator comprising:
a ceramic layer comprising ceramic particles and a binder, and
a functional layer on the ceramic layer and comprising inorganic particles having a working potential (vs Li/Li⁺) of greater than or equal to about 1 V and a binder.

2. The separator of claim 1, wherein
a thickness of the ceramic layer is about 1 μm to about 100 μm, and
a thickness of the functional layer is about 1 μm to about 20 μm.

3. The separator of claim 1, wherein the ceramic particles comprise at least one selected from among silicon oxide, aluminum oxide, boehmite, zinc oxide, zirconium oxide, zeolite, titanium oxide, barium titanate, strontium titanate, calcium titanate, aluminum borate, calcium carbonate, barium carbonate, lead oxide, cerium oxide, calcium oxide, magnesium oxide, niobium oxide, tantalum oxide, tungsten oxide, aluminum phosphate, calcium silicate, zirconium silicate, titanium silicate, montmorillonite, saponite, vermiculite, and hydrotalcite.

4. The separator of claim 1, wherein an average particle diameter (D50) of the ceramic particles is about 10 nm to about 30 μm.

5. The separator of claim 1, wherein based on 100 wt % of the ceramic layer, the ceramic particles are in an amount of about 50 wt % to about 99 wt %, and the binder is in an amount of about 1 wt % to about 50 wt %.

6. The separator of claim 1, wherein the inorganic particles of the functional layer comprise at least one selected from among lithium titanium oxide, lithium zirconium oxide, lithium aluminum oxide, lithium niobium oxide, lithium lanthanum oxide, lithium tantalum oxide, lithium zinc oxide, lithium titanium zirconium oxide, lithium lanthanum titanium oxide, lithium lanthanum zirconium oxide, lithium lanthanum titanium zirconium oxide, and lithium lanthanum zirconium aluminum oxide.

7. The separator of claim 1, wherein, in the functional layer, an average particle diameter (D50) of the inorganic particles is about 10 nm to about 30 μm.

8. The separator of claim 1, wherein, based on 100 wt % of the functional layer,
the inorganic particles are in an amount of about 50 wt % to about 99 wt %, and the binder is in an amount of about 1 wt % to about 50 wt %.

9. The separator of claim 1, wherein each of the binder of the ceramic layer and the binder of the functional layer each independently comprises at least one selected from among polyvinylidene fluoride, polyvinylidene fluoride-hexafluoropropylene, polyvinylidene fluoride-trichloroethylene, polyvinylidene fluoride-chlorotrifluoroethylene, polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyethylene, polypropylene, a styrene-butadiene rubber, an acrylated styrene-butadiene rubber, an acrylonitrile-butadiene rubber, polyamideimide, and polyimide.

10. The separator of claim 1, wherein each of the binder of the ceramic layer and the binder of the functional layer comprises at least one selected from among polyvinylidene fluoride, polyvinylidene fluoride-hexafluoropropylene, polyvinylidene fluoride-trichloroethylene, and polyvinylidene fluoride-chlorotrifluoroethylene.

11. A negative electrode-separator assembly for a rechargeable lithium battery, the negative electrode-separator assembly comprising;
a negative electrode,
a functional layer on the negative electrode and comprising inorganic particles having a working potential (vs Li/Li⁺) of greater than or equal to about 1 V and a binder, and
a ceramic layer on the functional layer and comprising ceramic particles and a binder.

12. The negative electrode-separator assembly of claim 11, wherein
a thickness of the negative electrode is about 20 μm to about 200 μm,
a thickness of the ceramic layer is about 1 μm to about 100 μm, and
a thickness of the functional layer is about 1 μm to about 20 μm.

13. The negative electrode-separator assembly of claim 11, wherein the ceramic particles comprise at least one selected from among silicon oxide, aluminum oxide, boehmite, zinc oxide, zirconium oxide, zeolite, titanium oxide, barium titanate, strontium titanate, calcium titanate, aluminum borate, calcium carbonate, barium carbonate, lead oxide, cerium oxide, calcium oxide, magnesium oxide, niobium oxide, tantalum oxide, tungsten oxide, aluminum phosphate, calcium silicate, zirconium silicate, titanium silicate, montmorillonite, saponite, vermiculite, and hydrotalcite.

14. The negative electrode-separator assembly of claim 11, wherein the inorganic particles of the functional layer comprise at least one selected from among lithium titanium oxide, lithium zirconium oxide, lithium aluminum oxide, lithium niobium oxide, lithium lanthanum oxide, lithium tantalum oxide, lithium zinc oxide, lithium titanium zirconium oxide, lithium lanthanum titanium oxide, lithium lanthanum zirconium oxide, lithium lanthanum titanium zirconium oxide, and lithium lanthanum zirconium aluminum oxide.

15. The negative electrode-separator assembly of claim 11, wherein
an average particle diameter (D50) of the ceramic particles is about 10 nm to about 30 μm, and
an average particle diameter (D50) of the inorganic particles of the functional layer is about 10 nm to about 30 μm.

16. The negative electrode-separator assembly of claim 11, wherein
the negative electrode comprises a current collector, and a negative electrode active material layer on the current collector,
the negative electrode active material layer comprises a negative electrode active material, and
the negative electrode active material comprises a carbon-based negative electrode active material.

17. The negative electrode-separator assembly of claim 16, wherein
the negative electrode active material further comprises a silicon-based negative electrode active material, and
the silicon-based negative electrode active material comprises at least one selected from among silicon, silicon oxide, a silicon-carbon composite, and a silicon alloy.

18. A rechargeable lithium battery, comprising:
the negative electrode-separator assembly of claim 11,
a positive electrode, and
an electrolyte.
